(19) United States
(12) Patent Application Publication
(10) Pub. No.: US 2019/0035312 A1
(43) Pub. Date: Jan. 31, 2019

(54) LIGHTED DISPLAY DEVICE

(71) Applicant: Thomas Killion, (US)

(72) Inventors: Thomas Killion, Indianapolis, IN (US); Samuel Werth, Indianapolis, IN (US)

(21) Appl. No.: 16/047,296

(22) Filed: Jul. 27, 2018

Related U.S. Application Data
(60) Provisional application No. 62/538,545, filed on Jul. 28, 2017.

(51) Int. Cl. G09F 13/22; F21V 8/00; F21V 23/04

(52) U.S. Cl. CPC G09F 13/22; G02B 6/006; G09F 2013/222; F21V 23/04; G02B 6/0088

(57) ABSTRACT

A display device has a holder and a display member through which light can be transmitted, and upon which a light indicia can be displayed. The holder includes a body having a hollow interior, a power source, a control member and a light source disposed within the hollow interior. The holder also includes a display member receiving aperture disposed adjacent to the light source and configured for permitting light emitted from the light source to be transmitted into the display member so that the light emitted by the light source can travel through the display member and illuminate the indicia.

### PRIORITY

The present invention claims benefit of priority to Killion et al., U.S. Provisional Patent Application Ser. No. 62/538,545 which was filed on 28 Jul. 2017, and which is fully incorporated herein by reference.

### I. THE TECHNICAL FIELD OF THE INVENTION

The present invention relates to lighted display devices, and more particularly, to a lighted display device having an interchangeable lighted display member. The present invention is particularly well suited for display devices that comprise user-wearable lighted badges.

### III. BACKGROUND OF INVENTION

A variety of badges are commonly used throughout the business and educational world. Many companies use badges as security measures that are embedded with various chips and electronic devices to allow the wearer to gain access to certain parts of a facility for example, or to otherwise track the user wearing the badge.

Badges are often used at conferences and trade shows. At conferences and trade shows, a badge serves a dual function. First, badges are used to identify persons who are authorized to be at the conference or trade show. Another function served by the badge is to identify the particular user, and/or to identify the organization with whom the user is associated. For example, at trade shows a person who is working a trade show booth will often have a badge that has the name of the company for which he works, along with the wearer's name.

A badge assembly often includes a lanyard that can extend around the user's neck, so that the user may wear the badge as something of a “necklace”. Alternately, the badge can be equipped with a clip that the user can use to clip the badge onto an article of clothing, such as a lapel or the like.

Other areas in which lanyard containing badges are used are on persons who are working events, such as security personnel and police officers, to identify them as law enforcement authorities. Many persons wear lanyard mounted badges at sporting events to hold their ticket, or to display to others that they have access to certain areas of the event.

Certain circumstances exist wherein the person wearing a badge wants to draw attention to the badge. For example, at a trade show, one would wish to draw attention to the badge that he or she is wearing, so that persons attending the trade show will both know the name of the person wearing the badge, and also the organization with which she is associated. For that reason, badges are often adorned with various decorations so that they do not appear to be so plain and thus are more likely to draw the attention of others.

Along with drawing others' attention, it is important that the badge be easy to read. For example, one would want a badge that has one's name in large enough letters so that it can be read easily by a person attending a trade show or looking at the badge, without the observer being required to stare too long at the person and badge to read the wearer's name.

As such, it is one object of the present invention to provide a lighted display member, such as a badge that can contain information, and that will help to draw the viewer's attention to the badge.

### III. SUMMARY OF THE INVENTION

In accordance with the present invention, a display device is provided that comprises a holder member and a display member through which light can be transmitted, and upon which a light indicia can be displayed. A holder member includes a body having a hollow interior, a power source, a control member and a light source disposed within the hollow interior. The holder also includes a display member receiving aperture disposed adjacent to the light source and configured for permitting light emitted from the light source to be transmitted into the display member so that the light emitted by the light source can travel through the display member and illuminate the indicia.

Preferably, the device also includes a switch member for selectively controlling the flow of electricity between the power source and the light source for controlling the illumination of the display. A coupler member is provided that is configured for selectively releasably engaging the display member for the control attachment in detachment of the display member to the holder member.

The display member can include at least one ramp tab receiving portion, and the coupler member can include at least one spring loaded tongue that includes a ramp member that is configured for engaging the ramp receiving portion. A display member preferably comprises a light conductive display member, through Which light can be conducted from the lighting members into the interior of the display member. The display member also includes the capability of receiving an indicia thereon. The indicia can be formed by a technique that serves to reflect the light passing through the display, to cause the light to be visible-in the, reflective surface(s) of the indicia. The indicia can be imprinted into the display such as by engraving, etching, or roughening the surface of the display.

Generally, any technique for roughening the surface or forming cavities within the surface will usually serve as a reflective surface that will be highlighted by the introduction of light into the display member, whereas the generally clear undisturbed portions will allow light to pass there through without having the visibility of the light that is achieved in the roughened indicia portion.

These and other features of the present invention will be understood by those skilled in the art upon a review of the drawings and description of the invention that is presented in this application, which represent the best mode of practicing the invention perceived presently by the Applicants.

### IV. BRIEF DESCRIPTION OF THE DRAWINGS

FIG. 1 is a perspective view of an assembled display member of the present invention shown in the unlit state;

FIG. 2 is a perspective view of the display member of the present invention as shown in the lighted state.

FIG. 3 is a front view of the display member of the present invention;

FIG. 4 is a front partially sectional view of the display device of the present invention showing both the display member and the holder;

FIG. 5 is a rear biased perspective exploded view of the holder member of the present invention showing the components thereof;

FIG. 6 is a front biased perspective view of the holder member of the present invention showing the components thereof;

FIG. 7 is a rear biased perspective view of the holder member of the present invention;

FIG. 7A is a bottom view of the holder member of the present invention showing the position of the display member receiving aperture;

FIG. 8 is an enlarged view of the front surface of the main body member of the holder of the present invention;

FIG. 9 is a rear perspective, exploded view of the holder components of the present invention;

FIG. 10 is a plan view of the inner surface of the front cover, and also showing a lanyard receiving passageway portion of the front cover;

FIG. 11 is a rear biased exploded view of the rear surface of the back cover and rear surface of the main body;

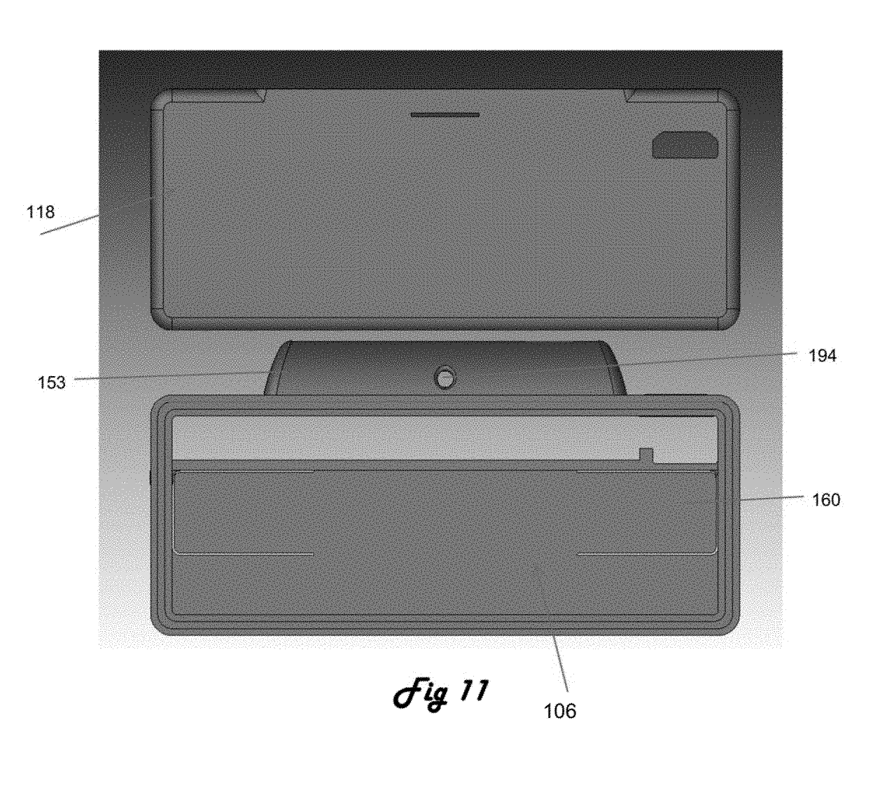

FIG. 12 is a perspective exploded front view showing the front cover, the switch button, and the circuit board;

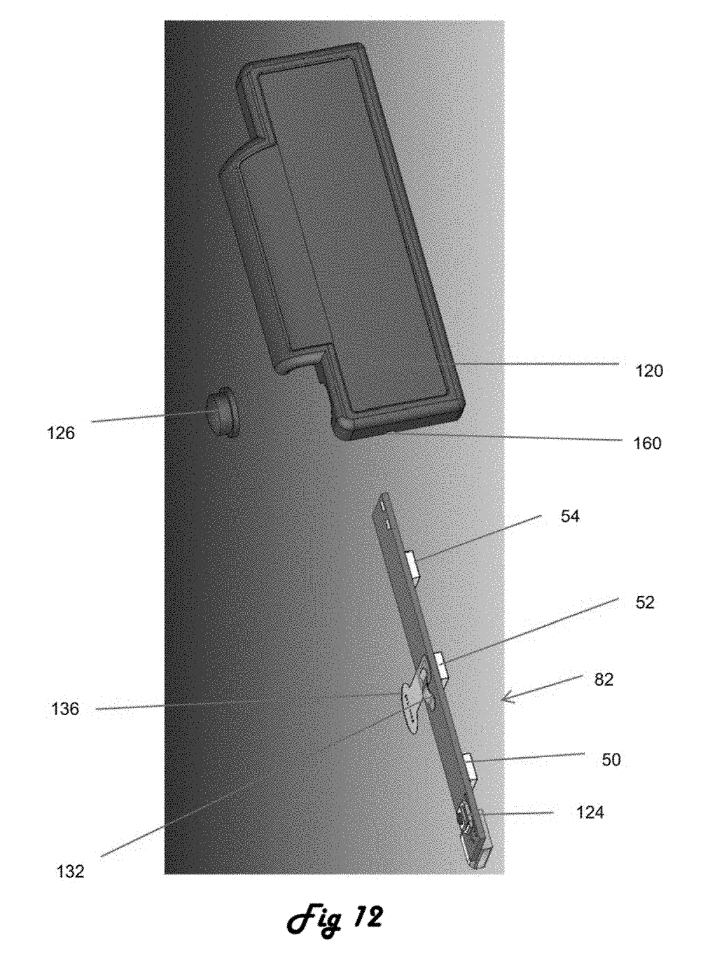

FIG. 13 is an enlarged view of the main body portion showing the spring loaded tongues and ramps thereon;

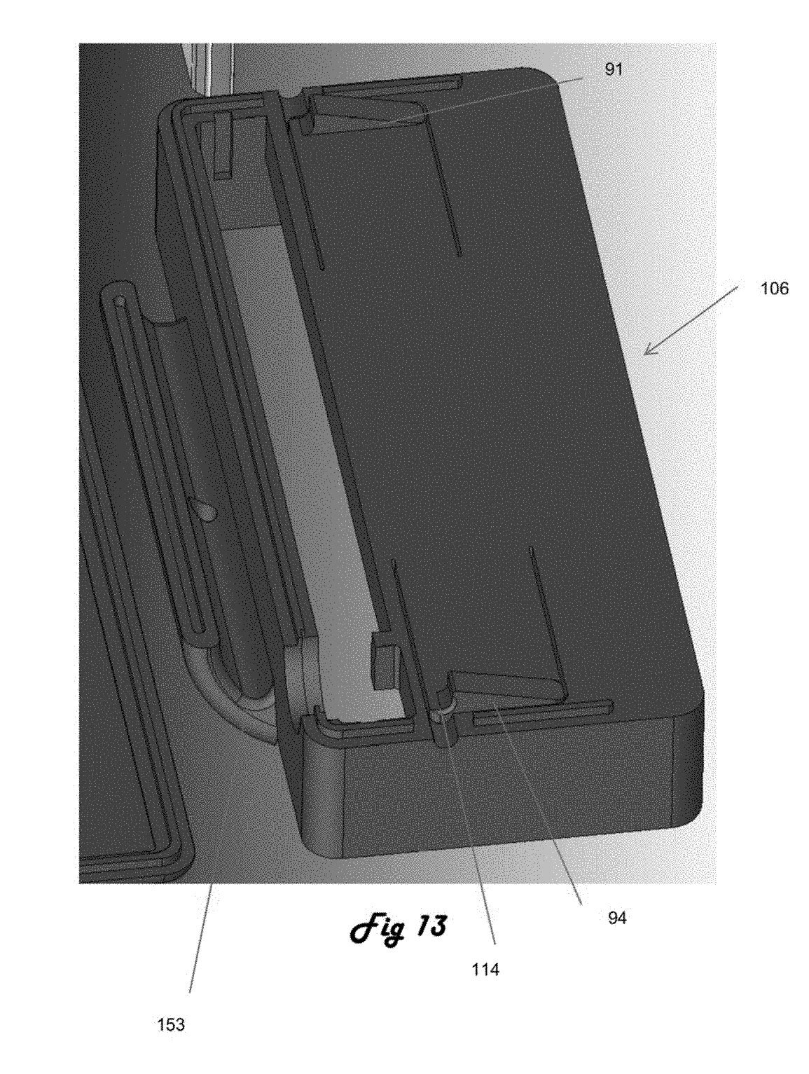

FIG. 14 is a rear biased perspective view of the interior surface of the front cover member and the circuit board including the USB port and the pull tab, which protects the battery terminal during shipping and storage;

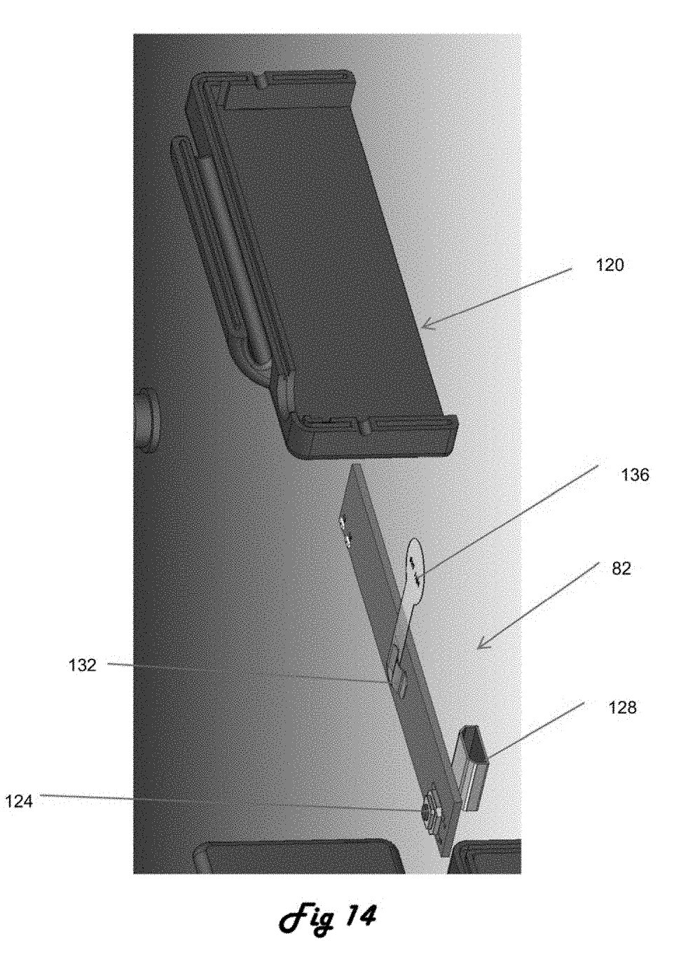

FIG. 15 is a rear view of the exterior surface of the rear (battery compartment) cover, the rear view of the main body member, and a rear view of the circuit board;

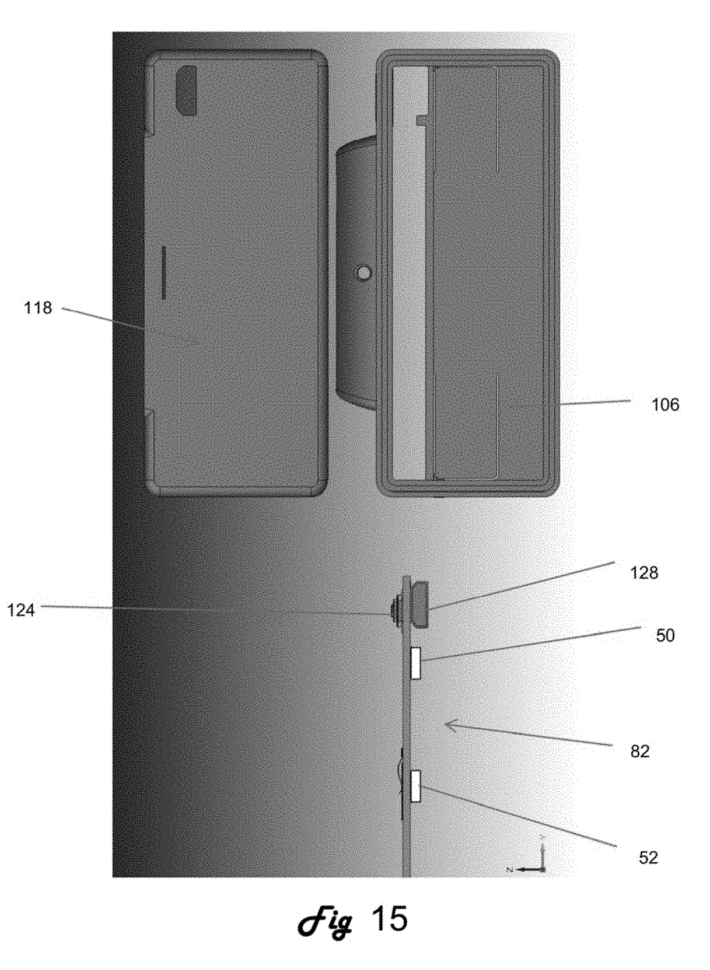

FIG. 16 is a frontal view of a pair of display devices of the present invention, it being noted that the display devices are capable of projecting different colors due to the use of the RGB LEDs of the present invention (if the drawing were in color, it would show one display device illuminated with a blue light and one display device illuminated with a green light).

FIG. 17 shows an alternate embodiment display member of the present invention that has an arcuate lateral cross sectioned profile; and

### V. DETAILED DESCRIPTION

The description that follows describes, illustrates and exemplifies one or more particular embodiments of the present invention in accordance with its principles. This description is not provided to limit the invention to the embodiment or embodiments described herein, but rather to explain and teach the principles of the invention in such a way to enable one of ordinary skill in the art to understand these principles and, with that understanding, be able to apply them to practice not only the embodiment or embodiments described herein, but also other embodiments that may come to mind in accordance with these principles.

The scope of the present invention is intended to cover all such embodiments that may fall within the scope of the appended claims, either literally or under the doctrine of equivalents.

It should be noted that in the description and drawings, like or substantially similar elements may be labeled with the same reference numerals. However, sometimes these elements may be labeled with differing reference numbers, such as, for example, in cases where such labeling facilitates a more clear description. Additionally, the drawings set forth herein are not necessarily drawn to scale, and in some instances proportions may have been exaggerated to more clearly depict certain features. Such labeling and drawing practices do not necessarily implicate an underlying substantive purpose.

Further, certain views are side views which depict only one side of the device (or one set of components of a multi set array of components), but it will be understood that the opposite side and other component sets are preferably identical thereto. The present specification is intended to be taken as a whole and interpreted in accordance with the principles of the present invention as taught herein and understood by one of ordinary skill in the art.

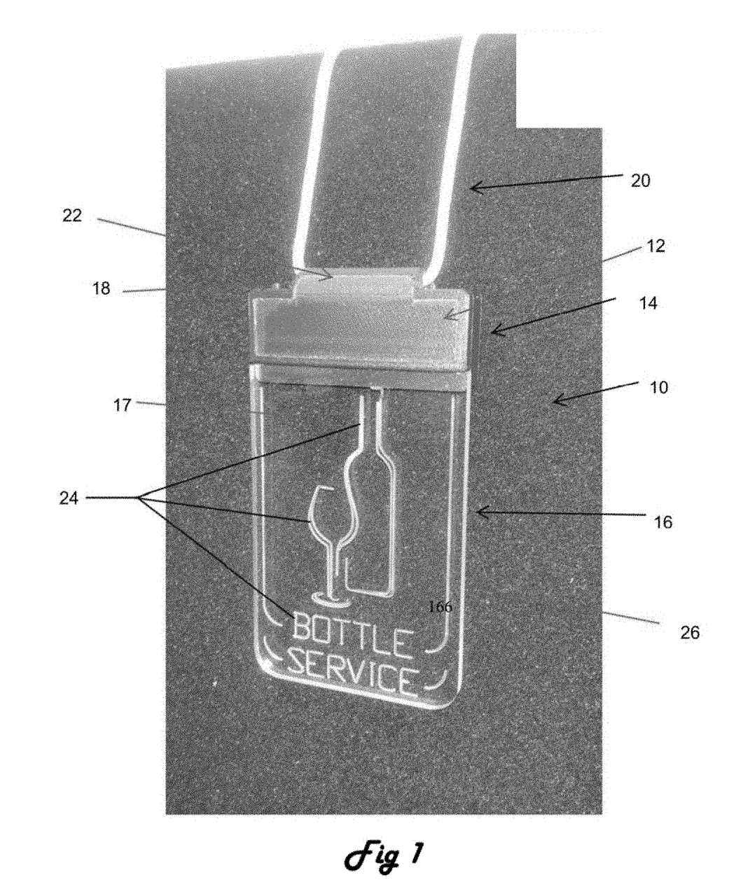

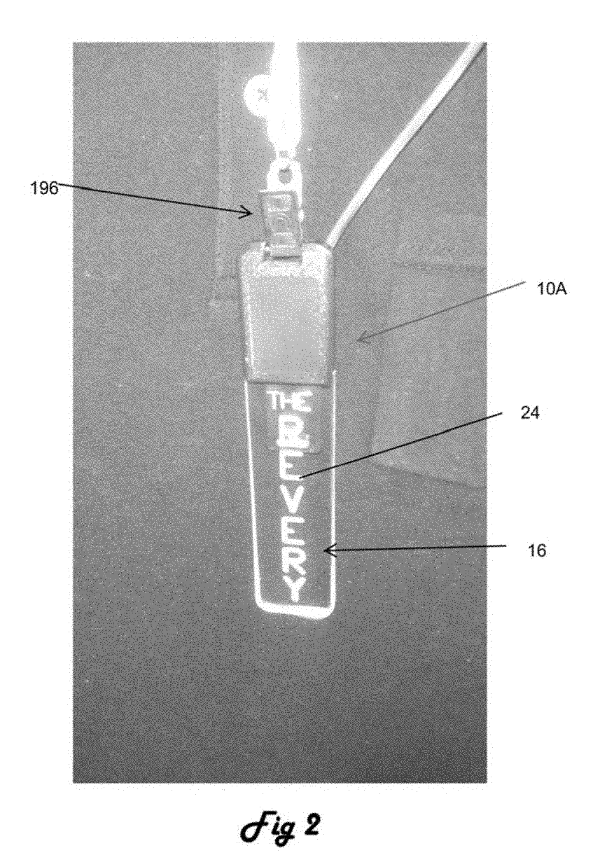

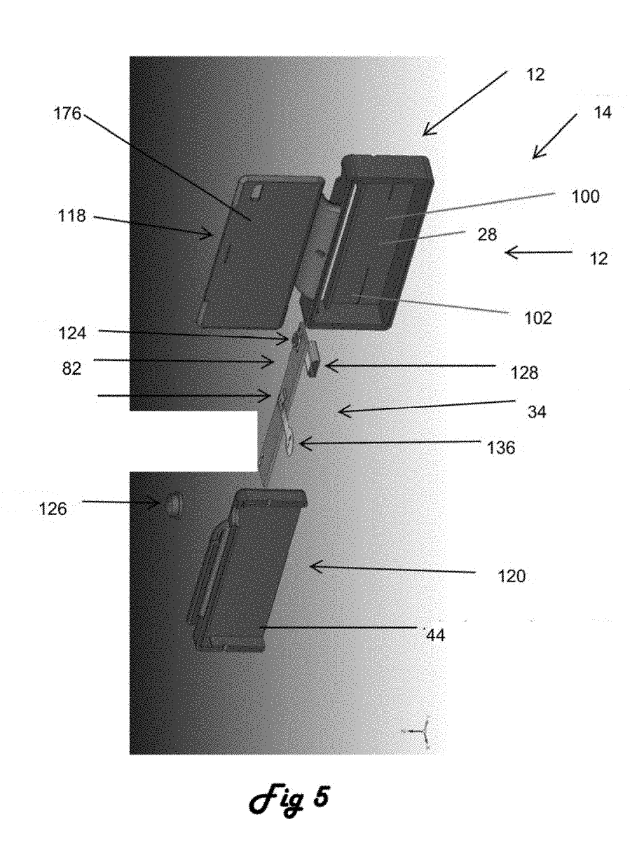

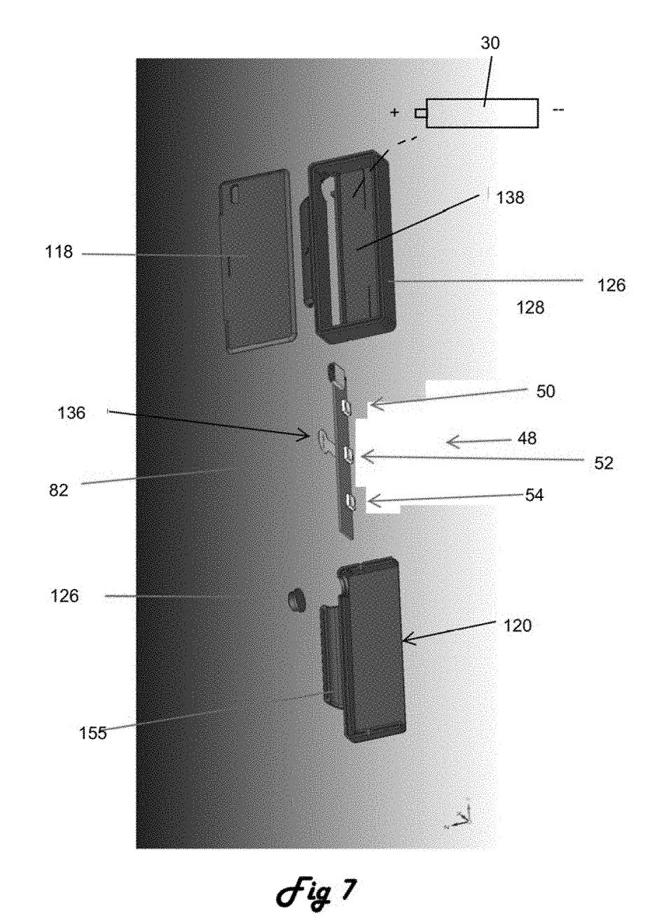

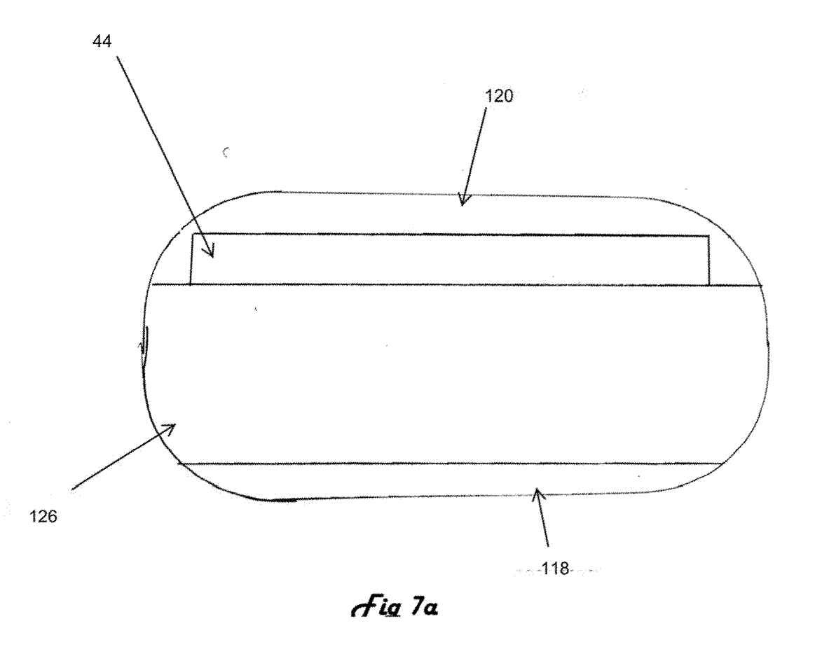

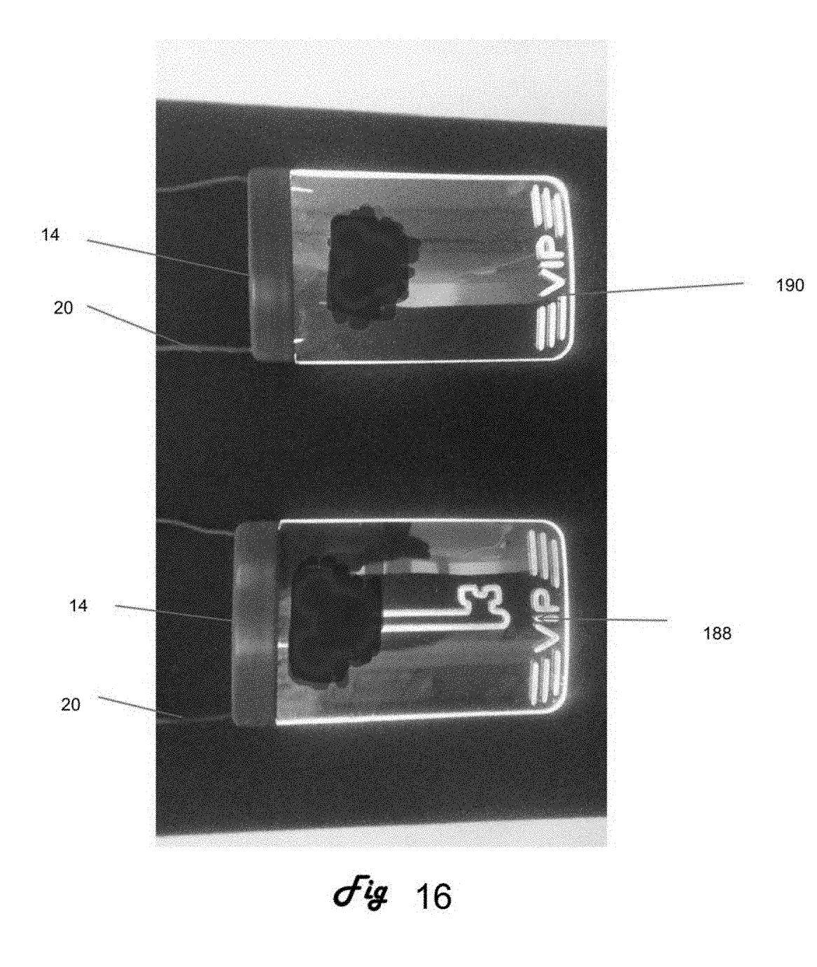

The display device 10 of the present invention is shown in the figure as including a holder 14 and display member 16 as its primary components. The holder member 14 includes a body or casing 12 that includes a hollow interior 28. Contained within the hollow interior 28 is a power source 30, such as a battery that may be an alkaline, but is preferably a watch-type circular disk WIH rechargeable battery or the like. The holder member 14 also includes a display member 16 receiving aperture 44 (FIG. 5) that is disposed adjacent to the light source 48, that is shown in FIG. 7 as including a first LED 50, a second LED 52 and a third LED 54. The display member receiving aperture 44 is configured to be disposed adjacent to the light sources 50, 52, 54 and is configured for permitting light that is emitted from the light sources 50, 52, 54 to be transmitted into the display member 16 so that light emitted by the light sources 50, 52, 54 can travel through the display member, and illuminate the indicia 24. The indicia displays a message such as “bottle service” (FIG. 1), “the Revery” (FIG. 2) and “VIP” (FIG. 16).

FIGS. 1 and 2 show the display device 10 of the present invention. The display device 10 includes a lanyard 20, that extends through a lanyard engaging portion 56 of the holder 14 that receives the lanyard 20. The display member 16 preferably comprises a clear plastic display, such as a polymethyl-methacrylate or polycarbonate clear display member 16, that is generally sheet like in configuration, and includes an indicia 24 thereon. The indicia 24 is formed by altering the surface of the otherwise transparent display member 16, so that the indicia 24 has reflective properties that are different than the reflective properties of the remainder of the transparent display member 16.

Those familiar with “fiber-optic” lighting will appreciate that one can apply light to a clear or transparent member, such as a polymethyl-methacrylate member 16 (known, e.g. Lucite®, Plexiglas®) to cause the light that is being introduced into the display member to be transmitted through the display member 16 to a remote location.

Polymethyl-methacrylate is used in the present invention to achieve “fiber-optic lighting”, wherein the light is illuminated by light source 48 into a polymethyl-methacrylate display member 16 at a first (proximal) end 58 and the light is transmitted through the polymethyl-methacrylate display member 16 to a second (distal) end 60 thereby wherein a roughened surface is applied so that light is emitted from the distal (second) end 60 of the display member 16. The placement of a roughened or otherwise reflective surface (such as at indicia 24) between the first end 58 and the second end 60 will reflect the transmitted light, to thereby cause the indicia to become illuminated, and thereby distinguishable from the areas around them. Such fiber-optic lighting is used in a wide variety of applications, such as medical instruments, and automobile parts and examples of lighted displays are disclosed in Brassine, U.S. Pat. No. 4,340,372; Knoll, U.S. Pat. No. 4,679,044; Kobayashi et al, U.S. Pat. No. 9,522,630; and Kermit Burgin, U.S. Pat. No. 4,300,541.

The display member 16 includes a clear portion 17 and an indicia portion 24, and an edge portion 26. The clear portion 17 and the indicia portion have different surface treatments so that, when lighted the indicia portion 26 appears different than the clear portion 17. The edge portion 26 will often have a roughened, light-diffusing surface to provide a glowing perimetral surface 26 to the display member 16.

The edge portion includes first 64 and second 66 opposed side edges, and proximal 68 and distal 70 end edges. The proximal 68 and distal 70 end edges are opposed to each other and each extends between the first 64 and second 66 opposed sides.

The indicia portion 24 itself is formed by employing an appropriate surface altering technique so that the applied indicia 24 is formed by creating a surface that has different reflective properties than the generally clear portion 17 Of the display member 16. This reflection can be created through a variety of techniques. For example, a CNC machine or other engraver can be used to actually engrave the indicia 24 into the display. Additionally, a laser can be used to “laser etch” an indicia. A wide variety of other techniques exist to create and form such indicia 24.

The final result of such etching can be shown in FIG. 2, that is intended to show a display in the “lighted” configuration. It will be noted that the indicia 24 of FIG. 2 comprises words, “THE REVERY.” The “light visible” portion of the display is the indicia means 24, as the reflective surface caused by the etching; engraving or the like, causes the light to be visible in that area so that the indicia becomes illuminated.

The indicia 24 can comprise any message that the user wishes to convey, and that can fit on the display. For example, the indicia can comprise names of the wearer of the display badge, such as Matt, Tom, Carla, etc. The fact that the names are lit makes the names easily identifiable to a person viewing them, so that the user (such as a customer at a trade show) can quickly identify the name of the person wearing the badge. Additionally, the logo portion helps to identify the company with whom the wearer is associated. Because the device 10 is lighted, the eye is naturally attracted to the display member 16 and the lighted indicia 24 thereon. This attraction to the eye will cause the viewer to look over at the display, to thereby receive an “advertisement” both for the company whose logo is displayed by the indicia 24 and also for the name of the user wearing the device 10.

Another interesting thing to note is the variety of display colors that can be achieved. This multi-colored application is achieved through the use of RGB LEDs 50, 52, 54 that have the capability of being lit in either blue light, green light or red light. Through the use of the RGB displays, one can illuminate the light in any one of the three primary colors of red, green and blue. Additionally, through a use of a combination of RGB displays, such as is achieved through the first, second and third LEDs 50, 52, 54, the device is actually capable of being displayed in over 12 colors, along with “white light”, and off positions.

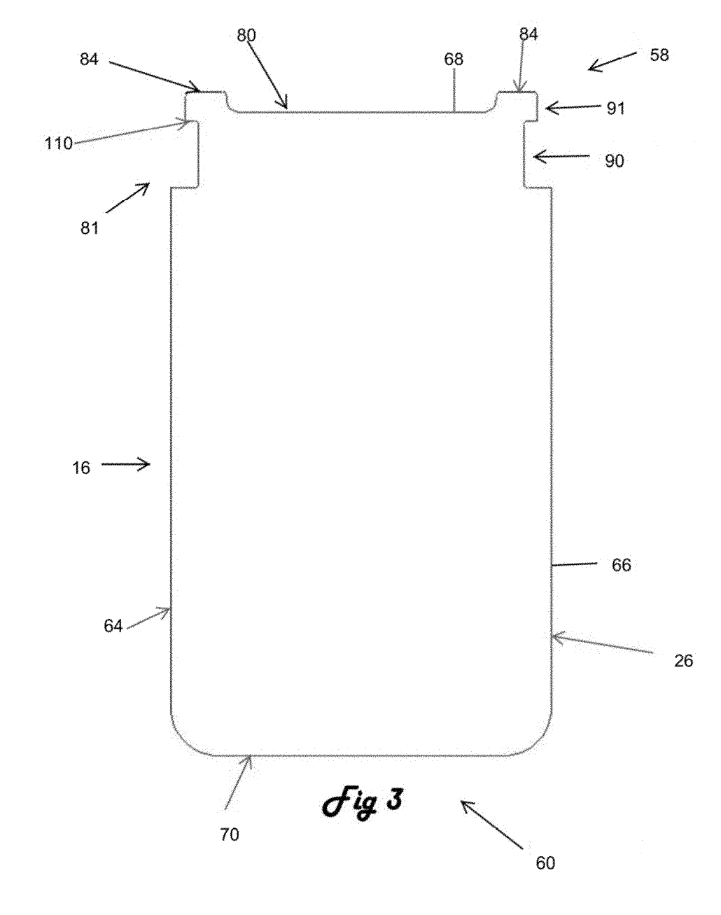

A display member 16 is shown in FIG. 3. The display member 16 is generally sheet-like and may be planar or arcuate, and is made from a light transmittable material, such as a polymethyl-methacrylate. The display member 16 includes an upper or proximal portion and a distal portion 16. The proximal portion 58 is so named because it is the portion that engages the holder member 14 and is insertable into the display receiving aperture 44. The distal portion 60 is the portion of the display member 16 that includes the indicia member 24.

The display member 16 is shown as generally being sheet-like and planar, and being generally rectangular in configuration, or more accurately, being a rounded rectangle. One of the features of the present invention is that it allows for a variety of shapes. The display member 16 is preferably formed by starting with a sheet of a light conductive material, such as Lucite®, that is approximately 0.375 inches thick. Of course, thicker and thinner display sheets also can be used.

The 0.375 inch thick display member is chosen because it is both sturdy enough to have good wear characteristics, but thin enough so as to be light, and be relatively easy to work with. The display member 16 is then cut from a larger sheet of the display material. The preferred way to cut the display member out of the larger sheet (not shown) is by laser cutting. Alternately, it can be sawn or cut with a blade in a stamping operation.

Because of the fact that the display member 16 can be cut, the shape of the cut can be changed by reprogramming the cutting device, such as the laser cutter to cut it into a different shape. This allows for a wide variety of display shapes to be employed, where the shapes that are limited only by notions of practicality, and the user's imagination. For example, display badges that are used at political conventions may have a shape similar to the state or nation in which the political party operates, or of the party mascot. Additionally, the display member 16 can take the shape of an animal, automobile logo or any other shape that the user desires.

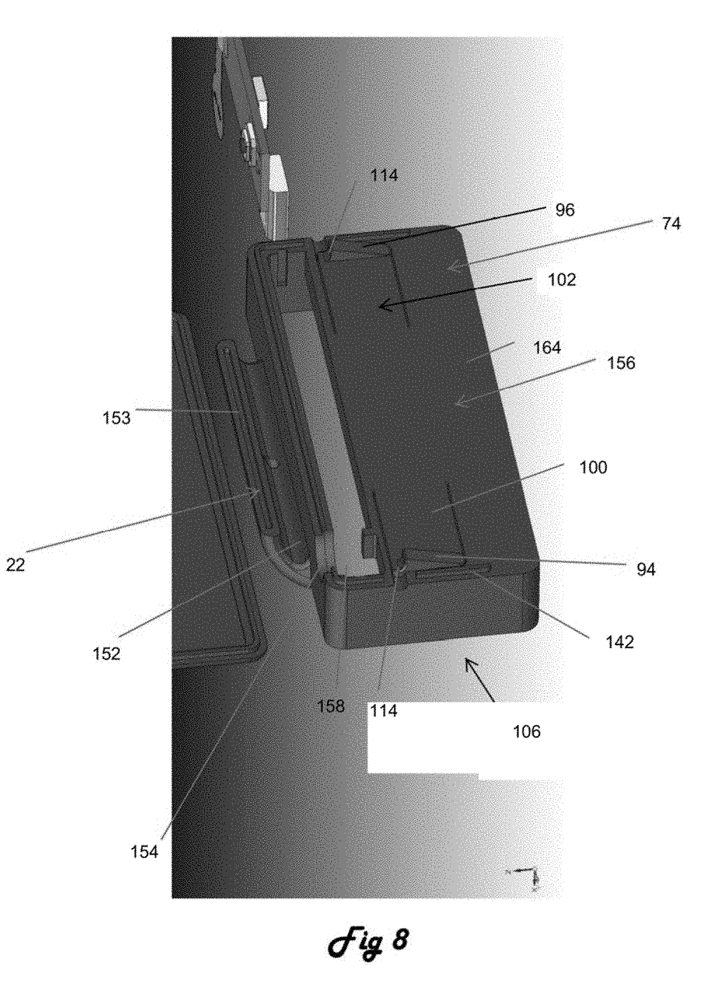

The only significant constraints relating to the shape of the display member 16 are imposed by those at the holder engaging portion 81. The holder engaging portion 81 has some display constraints because the display member 16 must be designed to be received into the display receiving aperture 44 and coupler 74 (FIG. 8) of the holder 14.

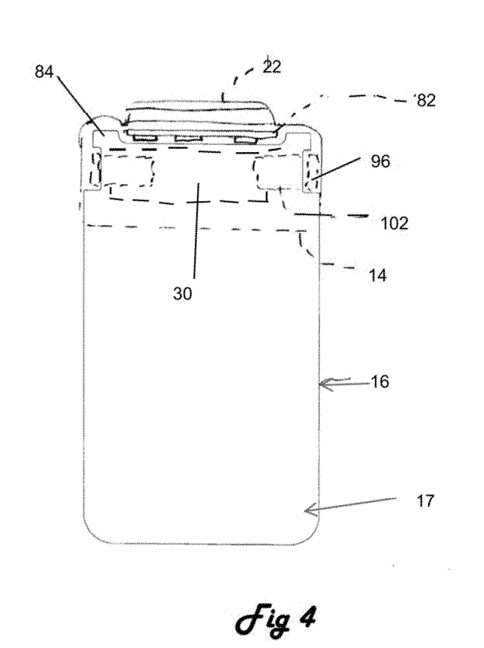

As shown in FIGS. 3 and 4, in the drawings, the top surface of the display member includes a dished out recessed portion 80 of the proximal surface 68. The recessed portion 80 of the top surface 68 is provided for receiving a circuit board 82 there above that includes the LED lights 50, 52, 54 thereon. The end tab members 84 extend upwardly to help provide protection to the LED's 50, 52, 54 and circuit board 82.

Along the side surfaces 64, 66, one goes from a relatively enlarged width portion 88, to a reduced width portion 90. The reduced width portion 90 is reduced, relative to the relatively enlarged width portion 91 of tab 84 to receive the upstanding first 94 and second 96 ramp members of first 100 and second 102 spring tabs that are formed on a main body member 106 of the housing 120 holder member 14. The spring tabs 100, 102 and display member end tabs 84 comprise the coupler member of the holder 14 for coupling the display member 16 to the holder member 14.

The display member 16 is prevented from disengaging from the holder member 14 primarily because of the engagement of the distal facing surface 110 of the relatively width tab members 84 with the proximal facing surface 114 of the ramp shaped ramp engaging members 94, 96 of the spring tab members 100, 102.

Apertures are formed along the side of the housing member, as will be discussed in more detail below, so that one can engage and move the tab members 100, 102 into and out of engagement with the display member 16, so that the display member 16 can be removed from the holder 14, and, if desired, be interchanged with another display member. Normally, the spring loaded tab members 100, 102 (also known as spring loaded tongues 100,102) are biased in their upwardly (outwardly), or display member engaging position. It should be noted that the spring loading in the tongues 100, 102 occurs as a result of their material and construction, and not through an external spring.

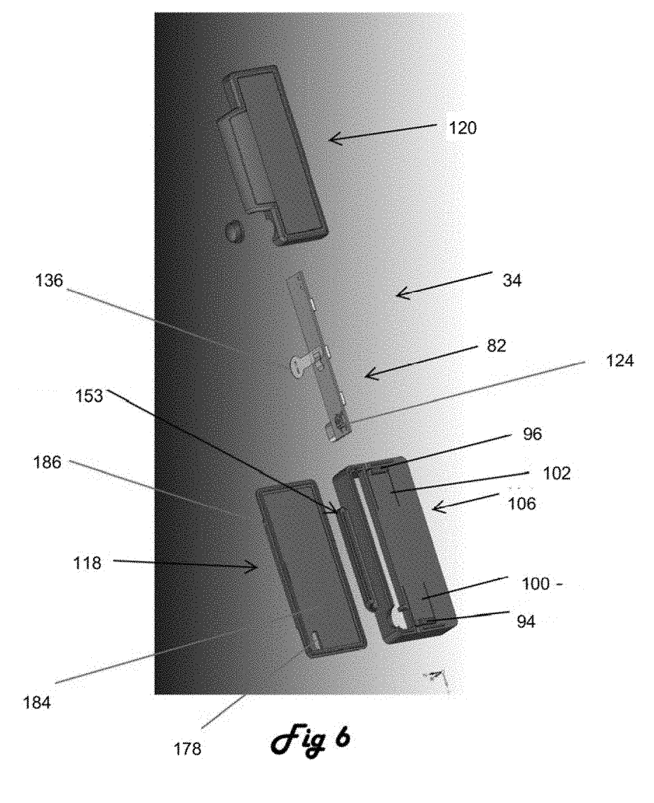

The primary components of the housing (body) 12 are best shown in FIGS. 5 and 6. The housing 12 and control member 34 comprise six primary components. These components include a central or main body member 10, a rear cover member 118, a front cover member 120, a light containing control member that comprises a circuit board member 82. The circuit board 82 includes three RGB LED lights 50, 52, 54 and a switch member including switch terminals 124 on the circuit board and a switch button 126. The circuit board 82 also includes a USB receiving port 121 for recharging the battery 30, a battery receiving terminal member 132 and a pull tab member 136.

The final member is a switch actuating button 126 that attaches to the housing 12, to enable the device to be turned on and off by the user. A battery member 30 is also provided to serve as a power source.

Turning now to the circuit board member 82, it will be noted that it is generally rectangularly longitudinal in shape and includes a switch member 124. The switch member 124 is an on-off member that controls the operation of the device 10. A USB receiving port 128 is provided so that one may attach a USB connection. Preferably, a micro USB port 128 is used to save space.

The micro USB port 128 can be coupled to the male USB port of a charging member, or any USB containing cable, that can transfer power from a power source, such as a lap top, computer charger, or battery back, into the USB port 128, so that the battery may be recharged. Preferably, the battery is a lithium ion or NiH type battery that is commonly used, and is sized for fitting appropriately within the battery receiving cavity 138 of the housing 12.

The lights 50, 52, 54 are preferably RGB LED lights. As RGB lights they are capable of either shining a red, green or blue light, as desired.

The switch 124 is a multi-positioned switch so that when one actuates the switch 124 on through its cycles, different lighting options are provided. For example the first cycle that occurs when one depresses the switch the first time, may be such that all the lights 50, 52, 54 may glow white (which is also capable of being lit by an LED light). Upon the second depression, the second cycle may cause all of the lights 50, 52, 54 to show red; and on the third cycle, all the lights 50, 52, 54 may be all green. Continuing onward, on the fourth cycle, all the lights 50, 52, 54 could be all blue. When depressing the switch for the fifth time, a combination may occur, such that two red 50, 52 and one blue 54 light may be shown, so that a purple light is displayed.

Through varying the combination of colors and lights shown, a plurality of colors can be formed so that the display can show not only the standard white, red, green and blue lights, but also a variety of colors such as purple, yellow, along with orangish yellows and the like. Although in theory, there could be an infinite number of colors, it is generally believe that one will limit it to what is believed to likely be the 11 or 12 most popular colors that people are going to want to use.

A terminal 132 is provided for conducting electricity from a battery 30 or other power source, to the lights 50, 52, 54. The terminal 132 is wired through the switch 124, so that current will flow to the lights 50, 52, 54 from the battery terminal only when so actuated by the switch 124. A non-conductive pull tab member 136 can be inserted between the board 82 and the terminal 132 for blocking the flow of electricity from the battery 30 to the lights 50, 52, 54. This is both done as a safety precaution and as a battery life lengthening vehicle. It is envisioned that prior to first using the display member, the user will remove the pull tab, thereby allowing current to flow between the battery 30 and the lights 50, 52, 54, thereby making the device “active” and further useable by the user.

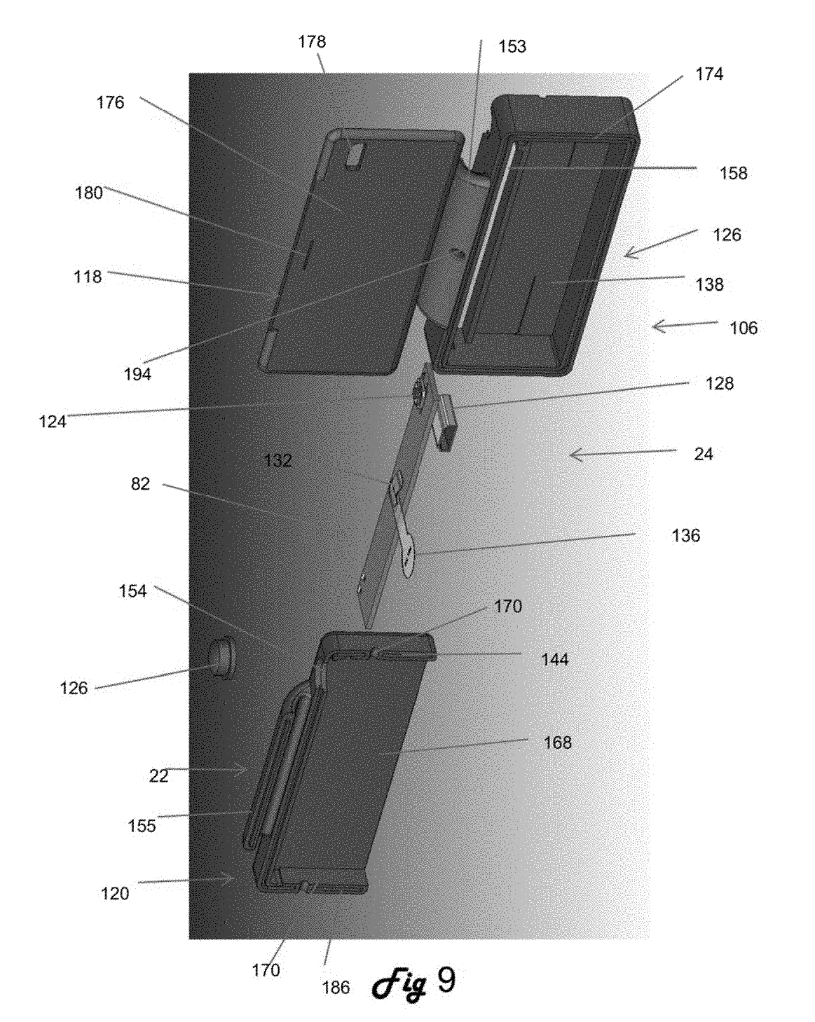

Turning now to FIGS. 8 and 9, the front (FIG. 8) and rear (FIG. 9) of the centrally disposed main body member 106 are shown. The main body member 106 shown in the figures is generally rectangularly cuboid in shape, having rounded edges and includes an interior battery receiving cavity 138. The front edge of the device includes a raised lip 142 for receiving a depressed slot of the front cover portion 120.

An arcuate lanyard engaging/receiving portion 22 is formed on the top of the outer surface of the housing member 12. The lanyard receiver portion 22 is formed by the mating of an elongated arcuate first mating half 153 formed on the main body member 106 and a second mating half 155 formed on the front cover portion 120.

This arcuate (in cross-section) lanyard receiving portion 22 includes a generally hollow passageway 152 area, for receiving a rope-like lanyard 20.

The top surface also includes a cutout portion 154 that forms an aperture for receiving the on-off button 126 that is inserted in the aperture 154, and controls the switch 124 and operation of the device 10. The switch button 126 enables the user to move the switch 124 between its various positions to thereby turn the lights of the display on and off, and to enable the device to cycle through the various colors.

The primary vertical panel 156 of the main body member 106 covers a portion of the interior cavity 28, but not the entire interior cavity 28. An elongated opening aperture is formed at the upper area of the rear portion of the central body member. A groove-like channel 160 is formed in the interior side surface of the central body member for receiving the circuit board 82 that contains the light switch 124 and terminal 132.

The space within the cavity 138 that is below the LED containing circuit board is sized and configured for receiving the battery 30. Preferably, the cavity 138 is large enough to receive a battery 30 that will have enough power so as to power the device 10 for reasonably long periods of time. One example of a battery that will fit in a most preferred embodiment is a 3.7 volt 500 milli-amp lithium polymer rechargeable battery, such as one made by Tenergy, and is described as model number 34062. As will be noted that the area above the LED board comprises an open area.

Turning now to FIG. 8, on a front view of the main body member 166, it will be noted that the front facing surface 168 of the main panel 156 of the body member includes a pair of spring tabs 100, 102. The spring tabs (tongues) 100, 102 include first 94 and second 96 ramps. When the device 10 is assembled, a display member receiving aperture is formed on the bottom surface of the device, between the front surface 164 of the main vertical panel 156, main body member 106 and the interior surface 166 of the front cover 120, so that the front surface 166 (FIG. 1) of the display member 16 engages the interior surface 168 of the front cover member.

To insert the display member 16 into the holder 14, the display member 16 is moved upwardly into the display receiving aperture. As that happens, the proximal portion 58 of the display member 16 engages the ramps 94, 96 that cause the spring loaded tabs 100, 102 to be pressed downwardly. The display member 16 continues to move upwardly until the radially upwardly and outwardly extending end tabs 84 of the display member 16 slide past the proximal end of the ramps 94, 96. This enables the ramps 94, 96 and spring loaded tab member 100, 102 to spring back forwardly to seat themselves in the relatively reduced width portion 90 of the proximal, holder engaging portion 81 of the display member 16.

The upper, proximal edges 114 of the ramps 94, 96 that are coupled to the spring tabs 100, 102 engage the distally facing surfaces 110 of the relatively enlarged width portion 91 of the display member 16 to prevent the display member 16 from moving distally out of its engagement with the holder 14. In order to distally remove the display member, one can insert an object through an aperture 170 formed in the side of the front cover member 120, to move the ramps downwardly, so that the display may be removed.

It should also be noted that on the rear of the main body portion a channel 174 is formed for receiving a lip of the back cover 118. Further, the lanyard receiving portion 153 of the main body member 106 includes a generally laterally extending channel for receiving a lip of the rear portion of the lanyard receiving portion 155 of the front cover 120.

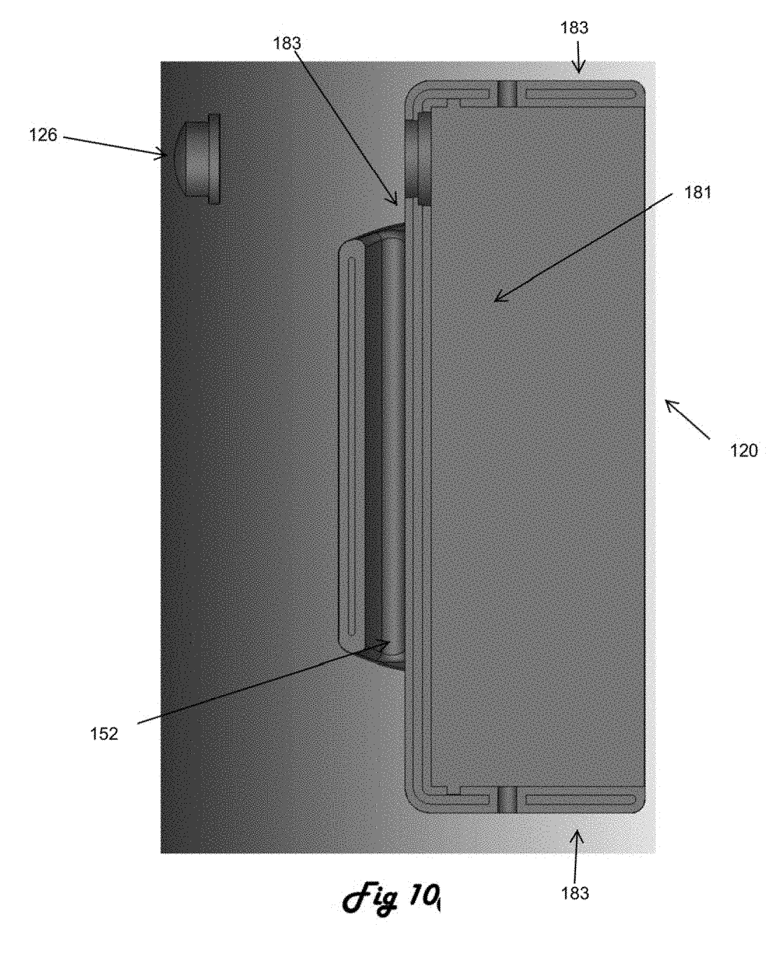

Your attention is next directed to the back cover that is best shown at FIGS. 5-7A, 9, 10. The outer surface 176 of the back cover is generally planar in configuration. It includes an aperture 178 that is sized for receiving a USB port, and preferably sized for receiving a micro USB port 128.

Extending lengthwise across the back of the cover is a generally linear slit 180. The linear slit 180 is sized and configured for receiving the pull tab cover 136. When a user buys a device 10, the pull tab 136 will extend through this linear slit 180 and have a portion of the pull tab that extends out of the linear slit 180. The user will then pull the pull tab 136 out of the slit 180, where the engagement between the pull tab 136 and the terminal will be broken, so that direct electrical contact can occur and current flow between the battery 30 and the lights 50, 52, 54. At that point, the slit 180 will probably stay open and exposed and the pull tab will be thrown away.

The interior surface of the back cover member is best shown at FIG. 6. The back cover member has a generally planar interior surface 184. The interior surface 184 is bordered by a “frame” that comprises an annular lip 186 that sticks outwardly from the back surface. This annular lip extends outwardly so that it may be engaged by the channel 174 in the rearwardly facing surface of the main body member 106.

Although the lip 186 can be shown as an annular lip that is received in an annular cavity, it can be a partial lip that extends only part of the way around the circumference of the back cover member 118. Such a partial lip is received by a partial channel 174 formed in the main body member 106.

Preferably, once the lip 186 of the back cover member 118 is engaged into the annular channel 174 of the main body member 106, the two parts will be joined together by radio frequency welding or sonic welding, so that the joinder between the two becomes permanent. When so joined, the back of the body member 106 seals the battery cavity. To some extent, the back cover member can be viewed as a “battery door”, that is molded separately from the main body member so that the battery can be inserted before the back cover is joined to the main body member. Although the battery cover door could be a removable battery cover door, it is believed by the Applicant that the efficient way to design the device is to use a rechargeable battery, and then RF weld the battery door over the back of the body member to thereby permanently seal the battery 30 inside the cavity and cover.

It is envisioned that at the end of the batteries' useful life, the display device will probably also be at the end of its useful life. Because of the novel and unobvious design of the present invention, it can be manufactured inexpensively enough so that it will not present an undue economic burden on the purchaser of the device 10 to just discard an old, no longer used device and replace it with a new device.

Your attention is now directed to the front cover member 120. The front cover member 120 includes a planar inner surface panel 181. The front cover member 120 also includes a lanyard receiving portion half 155, and a three-sided, side edge portion 183. The three-sided, side edge portion 183 includes an annular channel, for receiving a raised lip that is formed on the front side surface of the main body member.

When the front cover member 120 is joined to the main body member, the joinder is made permanent by sonically or RF welding the front cover member to the main body member. When so joined, a display member receiving cavity is formed that includes a display receiving aperture 44 (FIG. 7A) disposed at the distal surface of the housing holder member 14. The display receiving aperture 44 is generally sheet-like, and rectangular in cross section to receive the generally rectangular cross section display member therein.

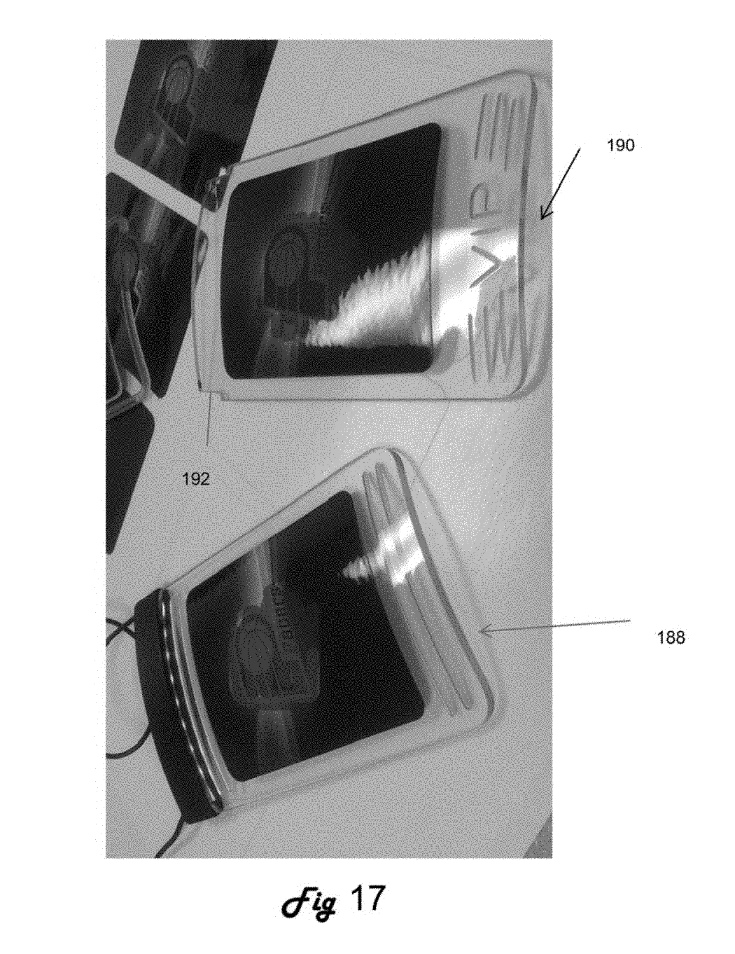

Although the display member shown is generally being sheet-like, it can take on a curved configuration. The curved configuration display member 188, 190 is shown in FIG. 17 and has the advantage of providing a particularly attractive device and display because of the way the curved nature radiates the light.

In order to create a curved display member 188, 190 one must adjust the sizing and shape of the parts, so that the display receiving aperture 44 is also relatively curved, so as to receive the curved display member 188, 190. Alternately, one could design the device so that the display member 188, 190 is curved on its distal portion, but planar on its upper proximal portion, so that the holder engaging portion 81 of the display member 188, 190 matches the size and shape of the planar display member discussed above.

Turning now to the main body member 106, it will be noted that there is an aperture 194 in the lanyard receiving portion 153. The aperture 194 serves as a lanyard position fixing aperture.

It is desirable to keep the lanyard 20 centered within the lanyard receiving passageway 152 of the holder member 140. This can be accomplished by creating an aperture 194, and placing a drop of solvent within the aperture 194. This drop of solvent helps to bond to the lanyard cord 20 to maintain the cord 20 in its centered position. This is preferably done so that the portion of the cord sticking out of the right portion of the passageway 152 stays approximately balanced with the left portion.

At the other end of the lanyard 20, a breakaway coupler member (not shown) is used so that if a force is exerted against the lanyard, the lanyard will come free of the coupler, so that the lanyard comes undone. This is done to prevent someone from getting snagged on the lanyard, and being unable to come un-snagged. It also helps the lanyard comply with ASTM requirements that govern such lanyard break away provisions.

It will be noted that the width of the passageway 152 is approximately an inch and a quarter long to provide an inch and a quarter passageway 152. This 1.25 inch passageway 152 is desirable because it helps to keep the badge 10 properly oriented. It is wide enough so that the front side will face away from the user's chest, and that the back side will be disposed adjacent to, and will face the user's chest.

If one were to use a shorter “clip” connection such as clip 196 shown in badge 10A, it is likely that the badge 10A would rotate about a longitudinal axis, so that the back side would face outwardly and the display would be displaying a person's name backward. This tends to make the device 10A unattractive to users. By keeping the badge 10A properly oriented, users are more receptive to using it and purchasing it. Nonetheless there are certain applications and uses where the clip 196 configuration of device 10A of FIG. 2 is preferred.

What is claimed is:

1. A display device comprising
a holder member and a display member through which light can be transmitted and upon which a lighted indicia can be displayed.
the holder member including a body having a hollow interior, a power source, a control member and a light emitting light source disposed within the hollow interior, and a display member receiving aperture disposed adjacent to the light source and configured for permitting light emitted from the light source to be transmitted into the display member so that the light emitted by the light source can travel through the display member and illuminate the indicia.

2. The display device of claim 1 further comprising a switch member for selectively controlling the flow of electricity between the power source and the light source for controlling illumination of the display.

3. The display device of claim 2 further comprising a coupler configured for selectively releasably engaging the display member for the controlled attachment and detachment of the display member to the holder member.

4. The display device of claim 3 wherein the display member includes at least one ramp receiving portion, and the coupler includes at one spring loaded ramp member configured for engaging the ramp receiving portion.

5. The display device of claim 4 wherein the spring loaded ramp member includes a bendable tongue portion and a ramp portion coupled to an end of the bendable tongue portion, the bendable tongue portion being movable by bending between an engaged position where the ramp portion engages the ramp receiving portion of the display member, and a disengaged position wherein the ramp portion is released from the ramp receiving portion.

6. The display device of claim 5 where the spring loaded ramp member comprises first and second spring loaded ramp members having, respectively, first and second bendable tongue portions and first and second ramp portions disposed adjacent to one end of the respective first and second bendable tongue portions.

7. The display device of claim 6 wherein the display member include a first and second opposed side edges, and the ramp receiving portion comprises a first ramp receiving portion disposed on the first side edge and second ramp receiving portion disposed on the second side edge.

8. The display device of claim 7 wherein the first side edge of the display member includes a first recessed portion that comprises the first ramp receiving portion, and the second side edge of the display member includes a second recessed portion that comprises the second ramp receiving portion.

9. The display device of claim 8 wherein the display member includes a third side edge configured with the first and second ramp receiving portions to be received within the display member receiving aperture for selectively coupling the display member to the holder member.

10. The display device of claim 9 where the display member comprises a sheet-like plastic member comprised of at least one of polycarbonate, and poly methyl methacrylate and wherein the indicia comprises a portion of a surface the display member that has been configured to reflect light transmitted through the indicia member.

11. The display device of claim 1 wherein further comprising a coupler configured for releasably engaging the display member for the controlled attachment and detachment of the display member to the holder member.

12. The display device of claim 1 wherein the holder member includes a coupler configured for selectively releasably engaging the display member for the controlled attachment and detachment of the display member to the holder member, and wherein the display member includes at least one coupler engaging member for engaging the coupler.

13. The display device of claim 12 wherein the display member includes first and second opposed side edges, and wherein the coupler engaging member includes a first coupler engaging member disposed on the first side edge, and a second coupler engaging member disposed on the second side edge.

14. The display device of claim 13 wherein the first side edge of the display member includes a first recessed portion that comprises the first coupler engaging member, and the second side edge of the display member includes a second recessed portion that comprises the second coupler engaging member.

15. The display device of claim 14 wherein the coupler includes a first spring loaded ramp member for selectively engaging the first recessed portion, and a second spring loaded ramp member for selectively engaging the second recessed portion.

16. The display device of claim 1 wherein the holder member includes a coupler for selectively engaging the display member for coupling the display member to the holder, the coupler being disposed adjacent to the display receiving aperture for engaging the display member when the display member is inserted in the display receiving aperture.

17. The display device of claim 16 wherein the coupler includes a release assembly for permitting the user to selectively release and attach the display member to the holder member to facilitate interchanging display members, wherein the coupler includes at least one spring loaded ramp member, and the display member includes a recessed portion for receiving the at least one spring loaded ramp member.

18. The display device of claim 1 wherein the display member includes a first side edge including a first recessed portion, and an opposed second side edge including a second recessed portion, the first and second recessed portions being sized and configured for being received within the display member receiving aperture for placing the display member next to the light source.

19. The display device of claim 1 further comprising a coupler member for selectively releasably engaging the display member for the controlled attachment of the display member to the holder member, the coupler including first and second spring loaded ramp members having, respectively, first and second bendable tongue portions disposed adjacent to one end of the respective first and second bendable tongue portion.

20. The display device of claim 1 wherein the body includes a lanyard engaging portion for permitting a lanyard to be coupled to the display device.
